(19) United States
(12) Patent Application Publication
(10) Pub. No.: US 2004/0080796 A1
(43) Pub. Date: Apr. 29, 2004

(54) Light gathering apparatus of scanner

(75) Inventor: Ann-Lun Lee, Kaohsiung (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: VEUTRON CORPORATION

(21) Appl. No.: 10/347,368

(22) Filed: Jan. 21, 2003

(30) Foreign Application Priority Data
Oct. 23, 2002 (TW) 91124586

(51) Int. Cl. H04N 1/04; H04N 1/46

(52) U.S. Cl. 358/509; 358/474

(57) ABSTRACT

A light gathering apparatus of a scanner is disclosed. A light source module of the light gathering apparatus is separated from a scanning module and is disposed on the main body of the scanner chassis, and a light gathering device and a light guiding device are used to guide light onto a scanning line of an original document. Because the light source module is separated from the scanning module, it is beneficial for miniaturization design of the scanner, and the scanner is easy to be cooled down, thereby decreasing noise and distortion resulted from a charged coupled device (CCD), reflection mirrors, or the main body of the scanning module being heated.

### FIELD OF THE INVENTION

The present invention relates to a light gathering apparatus of a scanner, and more particularly, to a light gathering apparatus of a scanner comprising a light source module separated from a scanning module.

### BACKGROUND OF THE INVENTION

Typically, a scanning light source of a scanner is installed on a scanning module within the main body of the scanner, and a cold cathode fluorescent lamp is usually used as the scanning light source. Referring to FIG. 1, FIG. 1 illustrates a cross-sectional view of a conventional scanner. A conventional scanner 100 consists essentially of a main body 102, and the main body 102 comprises a scanning module 104 having a light source 106 for scanning and a light gathering reflection piece 108, wherein the light gathering reflection piece 108 is located under the light source 106. An original document 110 desired to be scanned is deposited on an original document surface 114 of the main body 102.

While scanning the original document 110, the light source 106 emits light 112, and a portion of the light 112 is emitted to the original document 110 directly, and the other portion of the light 112 is gathered and then reflected to the original document 110 by the light gathering reflection piece 108 under the light source 106. At the same time, the scanning module 104 moves toward a direction 118 within the main body 102, so as to make the light 112 emitted from the light source 106 scan the original document 110 entirely. After the light source 106 has scanned the original document 110 entirely, the scanning module 104 moves toward a direction 116 to return the preparation position before scanning. After the light 112 emitted to the original document 110 is reflected, an image is produced and reflected into the scanning module 104. After the scanning module 104 processes the image, a digital image signal is formed and the scanning of the original document 110 is completed.

However, for pursuing the scanning devices of lightness, thinness, and miniaturization, the space of a scanning module for allocating a light gathering apparatus of a light source is compressed seriously, thus decreasing the light gathering area and reducing the using efficiency of the light source.

### SUMMARY OF THE INVENTION

In view of the conventional scanner, a light source module of a light gathering apparatus is allocated on a scanning module, and the space of the scanning module used for allocating a light gathering apparatus is getting smaller and smaller, so that the using efficiency of the light source is reduced. Besides, the light source module allocated on the scanning module further causes noise and distortion resulted from a charged coupled device (CCD), reflection mirrors, or the scanning module being heated.

Therefore, one major object of the present invention is to provide a light gathering apparatus of a scanner, by separating a light source module from a scanning module, and using a light gathering device and a light guiding device to guide light onto a scanning line of an original document. Hence, a light gathering reflection piece with large area can be used, thereby increasing the efficiency of the light source and benefiting the scanner to be cooled down.

Another object of the present invention is to provide a light gathering apparatus of a scanner, and the light gathering apparatus of the scanner separates a light source module from a scanning module, thereby preventing a charged coupled device, reflection mirrors, or the main body of the scanning module from being heated and from resulting in noise and distortion, thus enhancing the quality of the image.

A further object of the present invention is to provide a light gathering apparatus having a light source module separated from a scanning module, by adjusting the position of a light guiding piece within the main body of a scanner, wherein light can be emitted into a reflection mirror within an upper lid and reflected to a light guiding board to perform a transparent scanning step. Therefore, the scanner not only has the reflection-typed scanning function, but also has the penetration-typed scanning function.

According to the aforementioned purposes, the present invention further provides a light gathering apparatus of a scanner, fixed in one end within a main body of the scanner, wherein the scanner comprises an original document surface on the main body, a scanning module removable within the main body, and an upper lid located above the original document surface, the light gathering apparatus of the scanner comprising: a light source used to emit a plurality of light beams; a light gathering reflection piece used to gather the light beams to form and reflect a parallel light beam; and a light guiding device used to guide the parallel light beam reflected by the light gathering reflection piece to the original document surface. The scanning module comprises a first reflection mirror, and the light guiding device comprises a second reflection mirror located above the light gathering reflection piece, and the second reflection mirror is removable. When one reflection surface of the second reflection mirror is on the path of the parallel light beam reflected by the light gathering reflection piece, the second reflection mirror is used to reflect the parallel light beam. Besides, the light guiding device further comprises a lens set, and the lens set is used to reduce the scope of the parallel light beam reflected by the second reflection mirror, and to enable the parallel light beam to be transmitted to the first reflection mirror and then to be reflected to the original document surface, so as to perform a reflected scanning step.

In addition, the light guiding device also comprises a third reflection mirror located within the upper lid, and the upper lid further comprises a light guiding board. When the second reflection mirror is parallel to the parallel light beam reflected by the light gathering reflection piece, the parallel light beam is first reflected to the third reflection mirror and then reflected to the light guiding board by the third reflection mirror, and then reflected to the original document surface, so as to perform a transparent scanning step.

Because the light module of the light gathering apparatus is fixed within the main bode of the scanner, a light gathering reflection piece with larger area can be adopted to achieve the object of enhancing the utilization efficiency of the light source. Furthermore, the scanner can obtain the functions of both the reflection-typed scanning and the penetration-typed scanning by adjusting the removable second reflection mirror.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a cross-sectional view of a conventional scanner;

FIG. 2 illustrates a diagram showing the installation of a scanner while a reflection-typed scanning step is performed in accordance with a preferred embodiment of the present invention; and

FIG. 3 illustrates a diagram showing the installation of a scanner while a penetration-typed scanning step is performed in accordance with a preferred embodiment of the present invention.

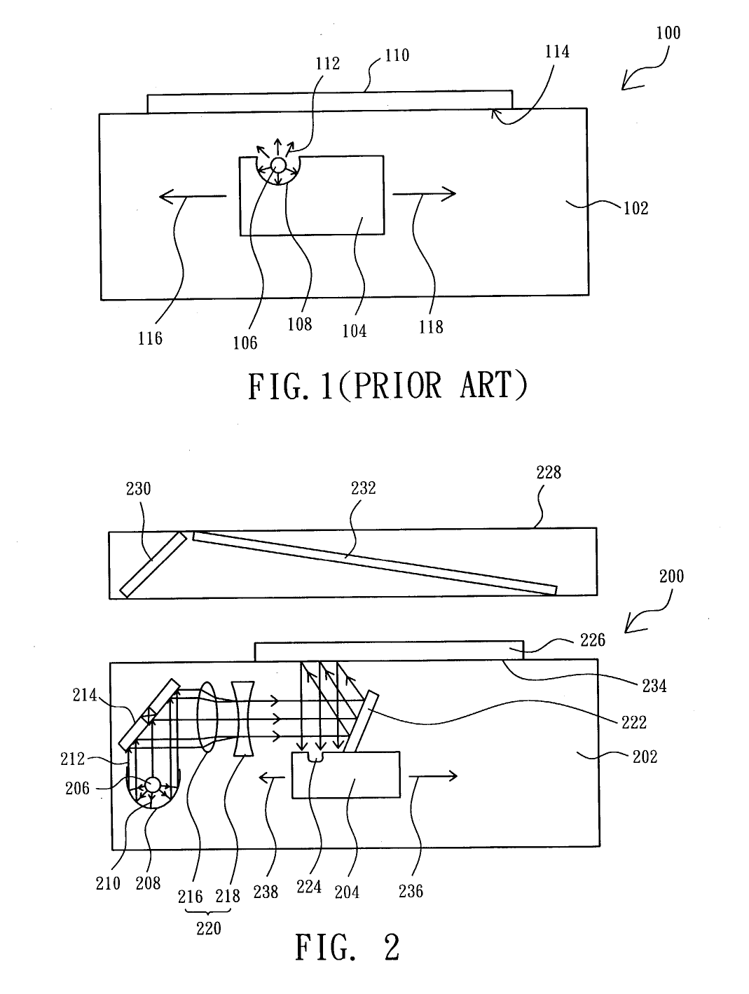

### DETAILED DESCRIPTION OF THE PREFERRED EMBODIMENT

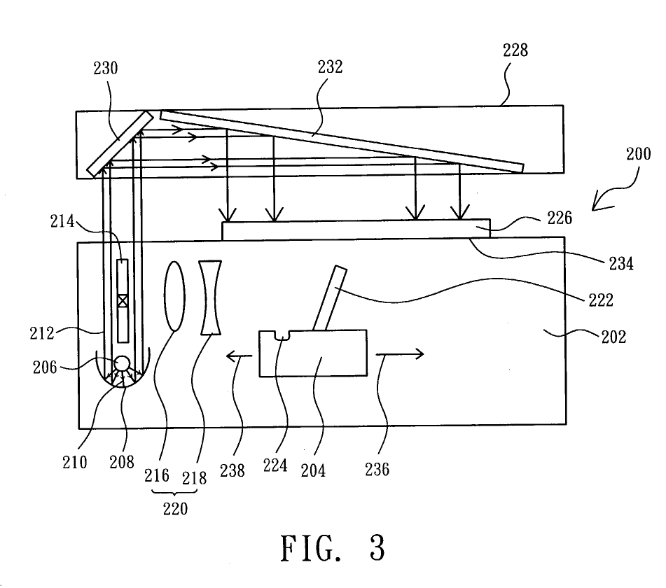

The present invention discloses a light gathering apparatus of a scanner, by removing a light source module of the light gathering apparatus from a scanning module and fixing the light source module within the main body of the scanner, thereby increasing the utilization space of a light gathering device to obtain the object of enhancing the utilization efficiency of a light source. In order to make the illustration of the present invention more explicitly and completely, the following description and the drawings from FIG. 2 and FIG. 3 are stated.

Referring to FIG. 2, FIG. 2 illustrates a diagram showing the installation of a scanner while a reflection-typed scanning step is performed in accordance with a preferred embodiment of the present invention. A scanner 200 comprises mainly a main body 202 and an upper lid 228, wherein the main body 202 comprises a scanning module 204 removable within the main body 202 and a light source module fixed in one end of the main body 202. The scanning module 204 further comprises a reflection mirror 222 and a receipted hole 224 used to receive the reflected image produced during scanning. The light source module comprises a light source 206, a light gathering reflection piece 208 under the light source 206, a reflection mirror 214 located above the light source 206, and a lens set 220 consisting of a convex lens 216 and a concave lens 218, wherein the light gathering reflection piece 208 can be such as a concave mirror. The lens set 220 is located between the reflection mirror 214 and the reflection mirror 222, and the reflection mirror 214 is removable, and the position of the reflection mirror 214 can be adjusted by, for example, rotating. An original document 226 desired to be scanned is deposited on an original document surface 234 of the main body 202 between the main body 202 and the upper lid 228. The upper lid 228 comprises a reflection mirror 230 and a light guiding board 232.

The reflection mirror 230 and the light module consisting of the light source 206, the light gathering reflection piece 208, the reflection mirror 214, and the lens set 220 construct a light gathering apparatus of the present invention.

While a scanning step of the original document 226 is performed, the light source 206 emits light 210, and a parallel light beam 212 is formed and reflected to the reflection mirror 214 after the light 210 is gathered by the light gathering reflection piece 208. When one reflection surface of the reflection mirror 214 is located on the path of the parallel light beam 212, such as shown in FIG. 2, the reflection mirror 214 reflects the parallel light beam 212 to the lens set 220 and makes the parallel light beam 212 pass through the convex lens 216 and the concave lens 218 in sequence, so as to reduce the range of the parallel light beam 212. After the parallel light beam 212 is transmitted to the reflection mirror 222 of the scanning module 204 by the lens set 220, the parallel light beam 212 is reflected to the original document 226, and a scanning image is formed and enters the receipted hole 224 of the scanning module 204. Then, an image-receiving step is completed by using such as an optical path device, a lens, and a charged coupled device etc. of the scanning module 204. As the scanning module 204 moves toward a direction 236, a reflected scanning step of the entire original document 226 is being completed. After the step of scanning the original document 226 entirely is completed, the scanning module 204 moves toward a direction 238 to return back to the preparation position. In the preferred embodiment, the reflection mirror 222 is a plane mirror, and the reflection mirror 222 of the present invention can be a concave mirror having a converging function.

Referring to FIG. 3, FIG. 3 illustrates a diagram showing the installation of a scanner while a penetration-typed scanning step is performed in accordance with a preferred embodiment of the present invention. When the reflection of the reflection mirror 214 is parallel to the parallel light beam 212, such as shown in FIG. 3, the parallel light beam 212 reflected by the light gathering reflection piece 208 passes through the main body 202 and reaches the reflection mirror 230 within the upper lid 228. The parallel light beam 212 is first reflected to the light guiding board 232 by the reflection mirror 230, and then the parallel light beam 212 passes through the upper lid 228 and reaches the original document 226. After the parallel light beam 212 passes through the original document 226 and the original document surface 234, a scanning image is formed. At this time, the scanning module 204 moves toward a direction 236 to make the scanning image enter the receiving hole 224, so that such as an optical path device, a lens, and a charged coupled device etc. of the scanning module 204 can be used to complete an image-receiving step. As the scanning module 204 moves toward the direction 236, a penetration-typed scanning step of the entire original document 226 is completing. After completing the step of scanning the entire original document 226, the scanning module 204 moves toward the direction 238 to return back to the preparation position.

According to the aforementioned description, one advantage of the present invention is that: because a light source module of the light gathering apparatus of the scanner is separated from a scanning module and fixed on the one end of the main body of a scanner, so that a light gathering reflection piece with large area can be used, thereby achieving the object of increasing the efficiency of the light source and benefiting the scanner to be cooled down.

Another advantage of the present invention is that: because a light source module is fixed within the main body of a scanner, but not on a scanning module, so that the scanner of the present invention can prevent a charged coupled device, reflection mirrors, or the main body of the scanning module from being heated and resulting in noise and distortion, thereby obtaining a high quality image.

A further advantage of the present invention is that: because a light beam can be reflected into a reflection mirror in an upper lid to perform a penetration-typed scanning step by adjusting the position of a light guiding piece within the main body of a scanner, so that the scanner not only has the reflection-typed scanning function, but also has the penetration-typed scanning function.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A light gathering apparatus of a scanner, fixed in one end within a main body of the scanner, wherein the scanner comprises an original document surface on the main body and a scanning module removable within the main body, the light gathering apparatus of the scanner comprising:
a light source used to emit a plurality of light beams;
a light gathering reflection piece used to gather the light beams to form a parallel light beam and to reflect the parallel light beam; and
a light guiding device used to guide the parallel light beam reflected by the light gathering reflection piece to the original document surface.

2. The light gathering apparatus of the scanner according to claim 1, wherein the light gathering reflection piece is a concave mirror.

3. The light gathering apparatus of the scanner according to claim 1, wherein the scanning module further comprises a first reflection mirror.

4. The light gathering apparatus of the scanner according to claim 3, wherein the first reflection mirror is a plane mirror.

5. The light gathering apparatus of the scanner according to claim 3, wherein the first reflection mirror is a concave mirror.

6. The light gathering apparatus of the scanner according to claim 3, wherein the light guiding device comprises:
a second reflection mirror located above the light gathering reflection piece within the main body, and the second reflection mirror is removable; and
a lens set located within the main body, and the lens set is used to reduce the scope of the parallel light beam,
wherein, when one reflection surface of the second reflection mirror is located on the path of the parallel light beam reflected from the light gathering reflection piece, the parallel light beam is reflected into the lens set by the reflection surface of the second reflection mirror, and the parallel light beam is transmitted to the first reflection mirror and then is reflected to the original document surface by the first reflection mirror.

7. The light gathering apparatus of the scanner according to claim 6, wherein the scanner further comprises an upper lid above the original document surface.

8. The light gathering apparatus of the scanner according to claim 7, wherein the light guiding device further comprises a third reflection mirror located within the upper lid, and the upper lid further comprises a light guiding board, and when the reflection surface of the second reflection mirror is parallel to the parallel light beam, the parallel light beam is reflected to the third reflection mirror within the upper lid and reflected to the light guiding board by the third reflection mirror, and then the parallel light beam is reflected to the original document surface.

9. The light gathering apparatus of the scanner according to claim 6, wherein the lens set comprises a convex lens and a concave lens.

10. A light gathering apparatus of a scanner, fixed in one end within a main body of the scanner, wherein the scanner comprises an original document surface on the main body and a scanning module that has a first reflection mirror and is removable within the main body, the light gathering apparatus of the scanner comprising:
a light source used to emit a plurality of light beams;
a light gathering reflection piece used to gather the light beams to form a parallel light beam and to reflect the parallel light beam; and
a light guiding device, wherein the light guiding device comprises:
a second reflection mirror located above the light gathering reflection piece, and the second reflection mirror is removable, and when one reflection surface of the second reflection mirror is on the path of the parallel light beam, the second reflection mirror is used to reflect the parallel light beam reflected by the light gathering reflection piece; and
a lens set, wherein the lens set is used to reduce the scope of the parallel light beam reflected by the second reflection mirror and enable the parallel light beam to be reflected to the original document surface by the first reflection mirror after being transmitted to the first reflection mirror.

11. The light gathering apparatus of the scanner according to claim 10, wherein the light gathering reflection piece is a concave mirror.

12. The light gathering apparatus of the scanner according to claim 10, wherein the first reflection mirror is a plane mirror.

13. The light gathering apparatus of the scanner according to claim 10, wherein the first reflection mirror is a concave mirror.

14. The light gathering apparatus of the scanner according to claim 10, wherein the scanner further comprises an upper lid above the original document surface of the main body.

15. The light gathering apparatus of the scanner according to claim 14, wherein the light guiding device further comprises a third reflection mirror located within the upper lid, and the upper lid further comprises a light guiding board, and when the reflection surface of the second reflection mirror is parallel to the parallel light beam reflected by the light gathering reflection piece, the parallel light beam is reflected to the third reflection mirror within the upper lid and reflected to the light guiding board by the third reflection mirror, and then the parallel light beam is reflected to the original document surface.

16. The light gathering apparatus of the scanner according to claim 10, wherein the lens set comprises a convex lens and a concave lens.
